(19) United States
(12) Patent Application Publication
(10) Pub. No.: US 2021/0010487 A1
(43) Pub. Date: Jan. 14, 2021

(54) FAN MOTOR

(71) Applicant: LG Electronics Inc., Seoul (KR)

(72) Inventors: Giyeob YANG, Seoul (KR); Jeongho LEE, Seoul (KR); Joongkeun CHOI, Seoul (KR); Seongho CHO, Seoul (KR)

(21) Appl. No.: 16/836,264

(22) Filed: Mar. 31, 2020

(30) Foreign Application Priority Data
Jul. 10, 2019 (KR) 10-2019-0083457

(51) Int. Cl. F04D 29/66; F04D 25/06

(52) U.S. Cl. CPC F04D 29/667; F04D 25/06

(57) ABSTRACT

Disclosed is a fan motor. The present disclosure provides a fan motor including a motor housing receiving a motor therein, an impeller coupled to a shaft of the motor, and a diffuser disposed between the motor and the impeller and having an axial flow vane and a diagonal flow vane.

### CROSS-REFERENCE TO RELATED APPLICATION

Pursuant to 35 U.S.C. § 119(a), this application claims the benefit of earlier filing date and right of priority to Korean Application No. 10-2019-0083457, filed on Jul. 10, 2019, the contents of which is hereby incorporated by reference herein in its entirety.

### BACKGROUND

### Field of the Disclosure

The present disclosure relates to a motor, and more particularly, to a fan motor.

### Discussion of the Related Art

A fan motor is a sort of an actuator that generates a rotational force. The fan motor generates a suction force by rotation of a fan (e.g., impeller) connected to a rotating shaft of a motor. Fan motors are used for various devices. Fan motors are used for home appliances such as cleaners, air conditioners, etc., cars, etc. For example, when a fan motor is used for a cleaner, air sucked by the fan motor flows into a filter of the cleaner.

Generally, a fan motor consists of a motor and an impeller connected to a rotating shaft of the motor. And, a diffuser may be provided between the motor and the impeller.

Once the motor rotates, the impeller connected to the rotating shaft is rotated as well. By rotation of the impeller, air is sucked in a direction of the impeller. The air coming out of the impeller is guided by a diffuser and then discharged in a direction of the motor.

Problems of a fan motor of the related art are described as follows.

First of all, problems of an impeller of the related art are described.

An impeller may include a hub and a multitude of blades provided to the hub. However, as the related art employs a centrifugal impeller, a centrifugal flow is generated from the impeller.

In the related art, a hub line of the impeller extends in a diameter direction, whereby a flow coming out of the impeller is discharged in the diameter direction. Therefore, the flow passing through the impeller is rapidly turned at almost 90 degrees and goes in a diffuser direction.

Generally, a flow path loss is heavy in an area where a flow is rapidly turned and flow path efficiency is poor. Yet, as described above, since the flow is rapidly turned in the related art impeller, a flow path loss is heavy and flow path efficiency is poor.

Problems of a diffuser of the related are described in the following.

A diffuser may include a hub and a multitude of vanes provided to the hub. Yet, as an axial flow diffuser is used in the related art, an axial flow is generated from the diffuser.

In the related art, the vanes are provided to the hub in an axial direction. Hence, a flow coming out of an impeller is rapidly turned to enter the vanes. This is because the flow comes out of the impeller in an approximately diameter direction and because the vanes of the diffuser are provided in an axial direction. Therefore, the related art diffuser has a heavy flow path loss and poor flow path efficiency.

Meanwhile, there exists a section (hereinafter referred to as ‘vaneless section’) in which no vane of a diffuser is present between an impeller and the diffuser, and such a vaneless section is long. However, the vaneless section fails to guide a flow due to absence of vanes. Therefore, in vaneless section of a related art fan motor, a flow path loss is heavy and flow path efficiency is poor.

Meanwhile, in the related art, a length of a vane of a diffuser is short. However, if the length of the vane of the diffuser is short, a flow cannot be guided effectively. Therefore, the related art diffuser has a small diffuser effect and poor flow path efficiency.

As described above, a related art fan motor has a heavy flow path loss in a diffuser. Therefore, the related art fan motor disadvantageously has poor flow path efficiency and lowered total efficiency of the fan motor. Moreover, as a fan motor is downsized and tends to have ultra-high speed, it is further necessary to reduce a flow path loss and improve flow path efficiency.

The above-described fan motor of the related art is disclosed in Korean Patent No. 1454083, U.S. Patent Laid-Open 2014/268636, European Patent No. 01025792 B1, U.S. Pat. No. 5,592,716, Korean Patent No. 1289026, Korean Patent Laid-Open No. 10-2014-0070303, etc.

### SUMMARY

Accordingly, embodiments of the present disclosure are directed to a fan motor that substantially obviates one or more problems due to limitations and disadvantages of the related art.

One object of the present disclosure is to provide a fan motor having an impeller capable of reducing a flow path loss and improving flow path efficiency.

Another object of the present disclosure is to provide a fan motor having a diffuser capable of reducing a flow path loss and improving flow path efficiency.

Another object of the present disclosure is to provide a fan motor capable of minimizing a vaneless section between an impeller and a diffuser.

Another object of the present disclosure is to provide a fan motor capable of maximizing a vane length of a diffuser.

Further object of the present disclosure is to provide a fan motor capable of improving efficiency of the fan motor.

Additional advantages, objects, and features of the disclosure will be set forth in the disclosure herein as well as the accompanying drawings. Such aspects may also be appreciated by those skilled in the art based on the disclosure herein.

According to an embodiment of the present disclosure, an impeller is a diagonal flow type. Hence, in the impeller, a flow path loss may be reduced and flow path efficiency may be improved.

According to an embodiment of the present disclosure, a diffuser includes a diagonal flow type. Hence, in the diffuser, a flow path loss may be minimized but flow path efficiency may be maximized.

According to an embodiment of the present disclosure, a vane of a diffuser, e.g., a diagonal flow vane is provided to a vaneless section. Hence, the vaneless section between an impeller and the diffuser may be minimized. Hence, a flow path loss may be minimized but flow path efficiency may be maximized.

According to an embodiment of the present disclosure, a diagonal flow vane is provided above an axial flow vane of a diffuser, thereby maximizing an overall length of the vane. Hence, a flow path loss may be minimized but flow path efficiency may be maximized.

To achieve these objects and other advantages and in accordance with the purpose of the disclosure, as embodied and broadly described herein, a fan motor according to one embodiment of the present disclosure may include a motor housing receiving a motor therein, an impeller coupled to a shaft of the motor, and a diffuser disposed between the motor and the impeller and having an axial flow vane and a diagonal flow vane.

According to an exemplary embodiment of the present disclosure, the impeller may be a diagonal flow type.

According to an exemplary embodiment of the present disclosure, the impeller may include a hub and a blade provided to the hub, and the hub may be inclined at a prescribed angle downward from horizontality.

According to an exemplary embodiment of the present disclosure, the hub may be inclined in an axial direction gradually from a top side to a bottom side.

According to an exemplary embodiment of the present disclosure, the diagonal flow vane may be located in a direction of the impeller.

According to an exemplary embodiment of the present disclosure, the diagonal flow vane may be in a shape that an angle of a leading edge is inclined.

According to an exemplary embodiment of the present disclosure, the axial flow vane and the diagonal flow vane may be integrally formed.

According to an exemplary embodiment of the present disclosure, the diffuser may include a hub and the axial flow vane and the diagonal flow vane may be located on an outer circumference of the hub.

According to an exemplary embodiment of the present disclosure, the hub may have a disk shape, the axial flow vane may be located on a lateral surface of the outer circumference of the hub, and the diagonal flow vane may be located on a top surface of the outer circumference of the hub.

According to an exemplary embodiment of the present disclosure, the top surface of the outer circumference of the hub may be a curved surface.

In another aspect of the present disclosure, as embodied and broadly described herein, a fan motor according to another embodiment of the present disclosure may include a motor housing receiving a motor therein, an impeller coupled to a shaft of the motor, a diffuser disposed between the motor and the impeller, and a vane disposed between the impeller and the diffuser.

According to an exemplary embodiment of the present disclosure, an axial flow vane may be provided to the diffuser and the vane disposed between the impeller and the diffuser may be a diagonal flow vane.

According to an exemplary embodiment of the present disclosure, the diagonal flow vane may be in a shape that an angle of a leading edge is inclined.

According to an exemplary embodiment of the present disclosure, the axial flow vane and the diagonal flow vane may be integrally formed.

According to an exemplary embodiment of the present disclosure, the impeller may be a diagonal flow type.

According to an exemplary embodiment of the present disclosure, the impeller may include a hub and a blade provided to the hub, and the hub may be inclined at a prescribed angle downward from horizontality.

According to an exemplary embodiment of the present disclosure, the hub may be inclined in an axial direction gradually from a top side to a bottom side.

In further aspect of the present disclosure, as embodied and broadly described herein, a fan motor according to further embodiment of the present disclosure may include a motor housing receiving a motor therein, a diagonal flow impeller coupled to a shaft of the motor, and a diffuser disposed between the motor and the impeller.

According to an exemplary embodiment of the present disclosure, the impeller may include a hub and a blade provided to the hub, and the hub may be inclined at a prescribed angle downward from horizontality.

According to an exemplary embodiment of the present disclosure, the hub may be inclined in an axial direction gradually from a top side to a bottom side.

The respective features of the above-described embodiments can be configured in a manner of being combined with other embodiments unless contradictory or exclusive to other embodiments.

Accordingly, a fan motor according to the present disclosure provides the following effects or advantages.

Firstly, according to an embodiment of the present disclosure, an impeller is a diagonal flow type. Hence, in the impeller, a flow path loss may be reduced and flow path efficiency may be improved, advantageously.

Secondly, according to an embodiment of the present disclosure, a diffuser includes a diagonal flow type. Hence, in the diffuser, a flow path loss may be minimized but flow path efficiency may be maximized, advantageously.

Thirdly, according to an embodiment of the present disclosure, a vane of a diffuser, e.g., a diagonal flow vane is provided to a vaneless section. Hence, the vaneless section between an impeller and the diffuser may be minimized. Hence, a flow path loss may be minimized but flow path efficiency may be maximized, advantageously.

Fourthly, according to an embodiment of the present disclosure, a diagonal flow vane is provided above an axial flow vane of a diffuser, thereby maximizing an overall length of the vane. Hence, a flow path loss may be minimized but flow path efficiency may be maximized, advantageously.

Effects obtainable from the present disclosure may be non-limited by the above mentioned effect. And, other unmentioned effects can be clearly understood from the following description by those having ordinary skill in the technical field to which the present disclosure pertains.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. The above and other aspects, features, and advantages of the present disclosure will become more apparent upon consideration of the following description of preferred embodiments, taken in conjunction with the accompanying drawing figures. In the drawings:

FIG. 1 is an exploded perspective diagram showing a fan motor according to an embodiment of the present disclosure;

FIG. 2 is a longitudinal cross-sectional diagram of FIG. 1;

FIG. 3 is a perspective diagram of an impeller shown in FIG. 1; and

FIG. 4 is a perspective diagram of a diffuser shown in FIG. 1.

### DETAILED DESCRIPTION

Reference will now be made in detail to a refrigerator according to the preferred embodiment of the present disclosure, examples of which are illustrated in the accompanying drawings. Although description will now be given in detail according to exemplary embodiments disclosed herein with reference to the accompanying drawings, the embodiments and drawings are used to help the understanding of the present disclosure.

Moreover, to help the understanding of the present disclosure, s the accompanying drawings may be illustrated in a manner of exaggerating sizes of some components instead of using a real scale.

Thus, the present disclosure is non-limited to the following embodiment, and it is intended that the present disclosure covers the modifications and variations of this disclosure provided they come within the scope of the appended claims and their equivalents.

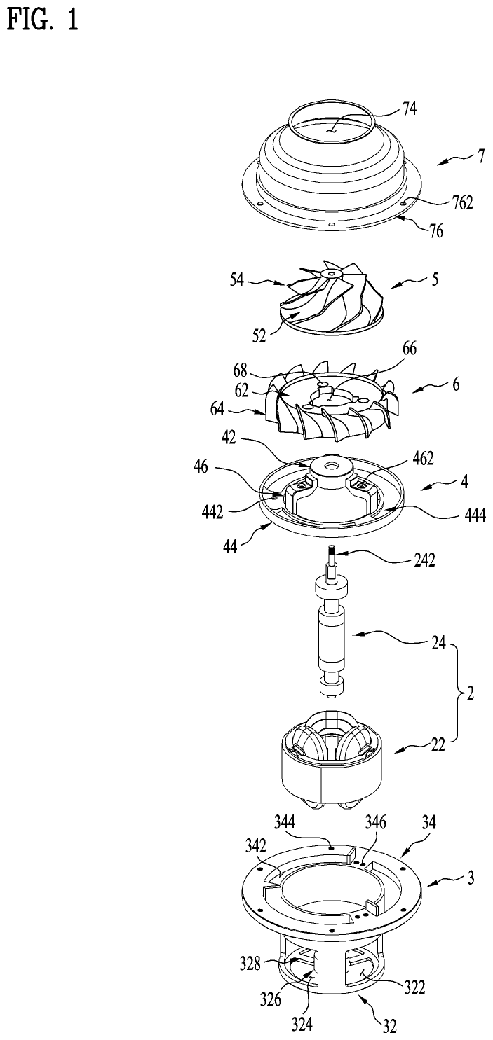

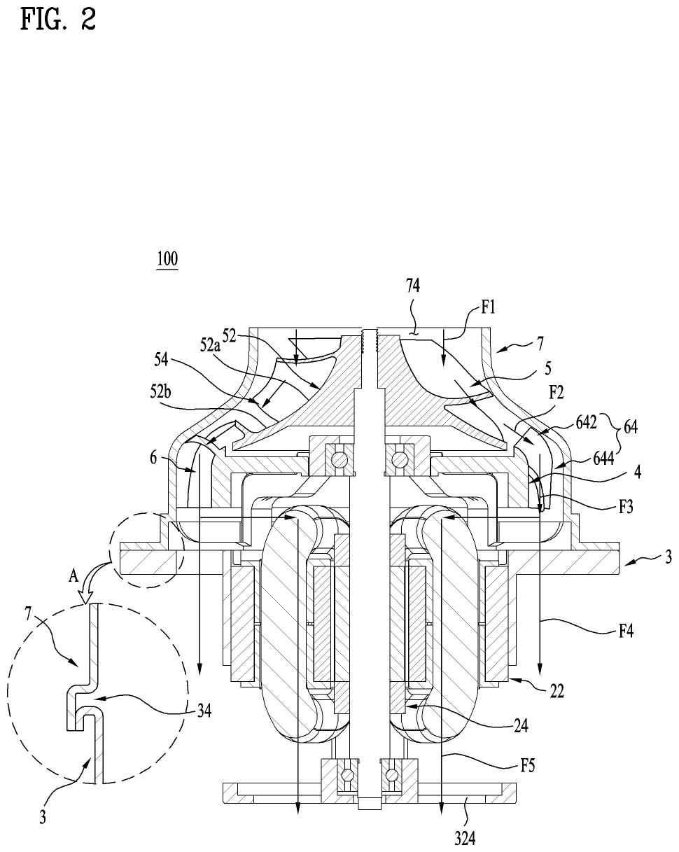

An overall configuration of a fan motor 1 according to an embodiment of the present disclosure is described with reference to FIG. 1 and FIG. 2 as follows.

First of all, a motor 2 may include a stator 22 and a rotor 24. An impeller may be coupled to a rotating shaft 242 of the rotor 24. Hence, if the motor 2 rotates, the impeller 5 rotates as well, thereby generating a suction force of sucking air.

A diffuser 6 may be provided between the impeller 5 and the motor 2. The diffuser 6 guides an air flow coming out of the impeller 5 toward a direction of the motor 2.

Meanwhile, the motor 2 may be received in a motor housing 3. A motor bracket 4 may be provided over the motor housing 3. The impeller 5 and the diffuser 6 may be received in an impeller housing 7.

The respective components are described in detail as follows.

First of all, the motor housing 3 is described.

The motor housing 3 may include a body 32 for receiving the motor 2 therein. A coupling part 34 extending in a radial direction may be provided to a top side of the body 32 of the motor housing 3.

The body 32 may have a hollow cylindrical shape overall. An opening 322 in a prescribed shape may be provided to a lateral side of the body 32. And, an opening 324 may be provided to a bottom side of the body 32. Air flowing into the motor housing 3 may be externally discharged through the bottom opening 324 of the body 32.

A bearing housing 326 (hereinafter referred to as ‘bottom bearing housing’, for clarity) for having a bearing seated therein may be provided to the bottom side of the body 32. And, a connecting part 328 may be provided to connect the bottom bearing housing 326 and the body 32 together.

Meanwhile, the opening 322 in the prescribed shape may be provided to the coupling part 34. A flow coming out of the diffuser 6 may move through the opening 342. A screw fastening recess 344 for coupling to the impeller housing 7 may be provided to the coupling part 34. And, a screw fastening recess 346 for coupling to the motor bracket 4 may be provided to the coupling part 34.

Meanwhile, the stator 22 may be coupled to an inner surface of the body 32 of the motor housing 3. The rotor 24 may be located around the center of the body 32 of the motor housing 3. A bottom side of the rotating shaft of the rotor 24 may be rotatably supported by the bottom bearing housing 326.

The motor bracket 4 is described in the following.

The motor bracket 4 may rotatably support a top portion of the rotating shaft of the rotor 24. Moreover, the motor bracket 4 may support the diffuser 6 by being coupled to the diffuser 6.

Detailed description is made as follows.

A bearing housing (hereinafter referred to as ‘top bearing housing’ for clarity) may be provided around the center of the motor bracket 4. A support part 44 supported by the coupling part 34 of the motor housing 32 may be provided to an outside of the motor bracket 4. The support part 44 may correspond to a shape of the coupling part 34. For example, the support part 44 may be in a ring shape.

An auxiliary support part 444 may be provided inside the support part 44. The auxiliary support part 444 may be in a ring shape. A part configured to connect the support part 42 and the auxiliary support part 444 together may be provided, and a screw fastening recess 442 may be provided to this part.

The support part 44 may be provided with a screen fastening recess 442 corresponding to the screw fastening recess 346 of the coupling part 34 of the motor housing 3.

A bridge 46 may be provided between the top bearing housing 42 and the support part 44 to connect them together. And, the bridge 46 may be provided with a screw fastening recess 462 corresponding to the screw fastening recess 68 of the diffuser 6. (A specific coupling structure will be described later.)

The impeller housing 7 is described as follows.

First of all, the impeller housing 7 may receive the impeller 5 and the diffuser 6 therein. The impeller housing 7 may be approximately configured in a hollow cylindrical shape. An opening 74 provided to a top side of the impeller housing 7 may become an inlet through which air flows in.

The impeller housing 7 may have a diameter increasing from top to bottom. A coupling part 76 extending in a radial direction may be provided to a bottom side of the impeller housing 7. The coupling part 76 of the impeller housing 7 may be provided with a screw fastening recess 762 corresponding to the screw fastening recess 344 of the coupling part 34 of the motor housing 3.

The coupling relationship of the respective components will be described as follows.

First of all, the top portion of the rotating shaft 242 of the rotor 24 may be rotatably supported by the top bearing housing 42 of the motor bracket 4. The bottom portion of the rotating shaft 24 of the rotor 24 may be rotatably supported by the bottom bearing housing 326 of the motor housing 3. The motor bracket 4 may be screw-fastened to the top side of the motor housing.

The diffuser 6 may be screw-fastened to the top side of the motor bracket 4. And, the impeller 5 may be coupled to the top end of the rotating shaft 242 of the rotor 24.

Meanwhile, the coupling part 76 of the impeller housing 7 may be screw-coupled to the coupling part 34 of the motor housing 3. Hence, the components of the fan motor 1 may be received in the impeller housing 7 and the motor housing 3.

Alternatively, the impeller housing 7 and the motor housing 3 may be coupled together by another coupling mechanism. For example, a part A shown in FIG. 2 shows another coupling mechanism. As shown in the part A of FIG. 2, the motor housing 3 may be pressed and fitted into the motor housing 3 so as to be coupled thereto. In this case, an edge of the coupling part 34 of the motor housing 3 may be bent downward and then press-fitted into the impeller housing 7.

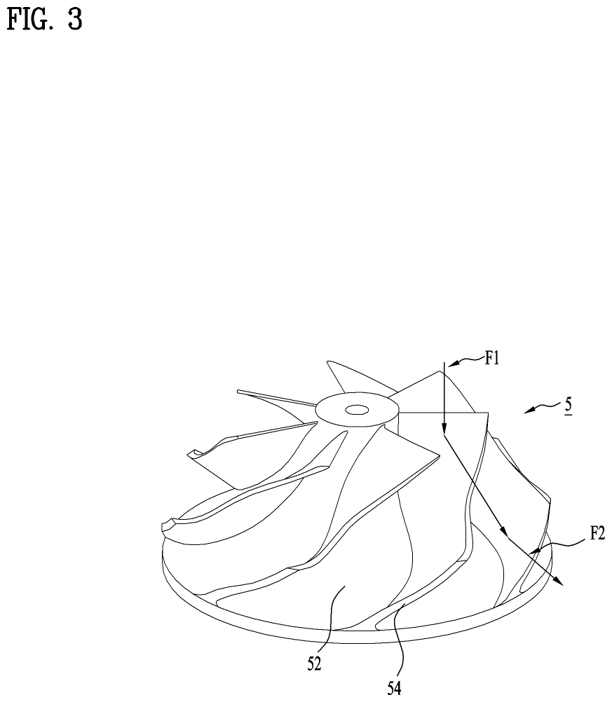

The impeller 5 of the present embodiment is described with reference to FIG. 3 as follows.

The present embodiment proposes a structure for decreasing a turned angle of a flow coming out of the impeller 5 to reduce a flow path loss.

The impeller 5 of the present embodiment may be a diagonal flow type. A flow F1 entering the impeller 5 through the inlet 74 of the impeller housing 7 almost follows an axial direction. Yet, a flow F2 coming out of the impeller 5 may have a prescribed inclination.

For example, the impeller 5 may be configured in a manner that a direction of the flow F2 coming out of the impeller 5 has an inclination between a diameter direction (0°) and the axial direction (90°). The direction of the flow F2 coming out of the impeller 5 may include about 45°.

Detailed description is made as follows.

The impeller 5 may include a hub 52 and a multitude of blades 54 provided to the hub 52. Here, the hub 52 may have an approximately circular shape. The blades 54 may be provided to a top side of the hub 52.

The direction of the flow F2 coming out of the impeller 5 may be set to have a prescribed downward inclination from a radial direction. To this end, the impeller 5 may be configured to be inclined further downward from horizontality. For example, in case of viewing a vertical cross-section of the hub 52 of the impeller 5, an inclination of a hub top surface 52a and 52b may be configured to have an angle between 0° and 90°, and preferably, 45°. Alternatively, the top surface of the hub 52 may be configured to have an inclination getting closer to the axial direction from the top side 52a toward the bottom side 52b. According to this configuration, a flow may be generated in a manner of getting proximate to the axial direction toward an outside from the hub 52 (See FIG. 2).

With the above configuration, the direction of the flow F2 coming out of the impeller 5 may become more slant downward than the diameter direction. Thus, the direction of the flow coming out of the impeller 5 may be prevented from being rapidly turned in the diameter direction. Therefore, a flow path loss may be minimized but flow path efficiency may be maximized.

Compared to a flow direction of a centrifugal impeller of the related art, a flow direction of the impeller 5 of the present embodiment is considerably inclined downward, i.e., in the axial direction so as to increase a flow rate of the axial direction. Therefore, a flow rate through the fan motor 1 increases, whereby a suction capability of the fan motor 1 increases.

Compared to a flow rate of a centrifugal impeller of the related art, a flow rate of the impeller 5 of the present embodiment is high. According to the comparison with the same reference, the number of blades of the impeller can be reduced. For example, if the number of blades of the centrifugal impeller of the related art is 9, although the number of the blades 54 of the impeller 5 of the present embodiment is reduced to 7, a sufficient flow rate can be secured.

In addition, if the number of the blades 54 of the impeller 5 is reduced, the shaft power applied to the impeller 5 is reduced. Therefore, since it is possible to reduce the shaft power in the impeller 5 of the present embodiment, efficiency of the fan motor 5 is raised.

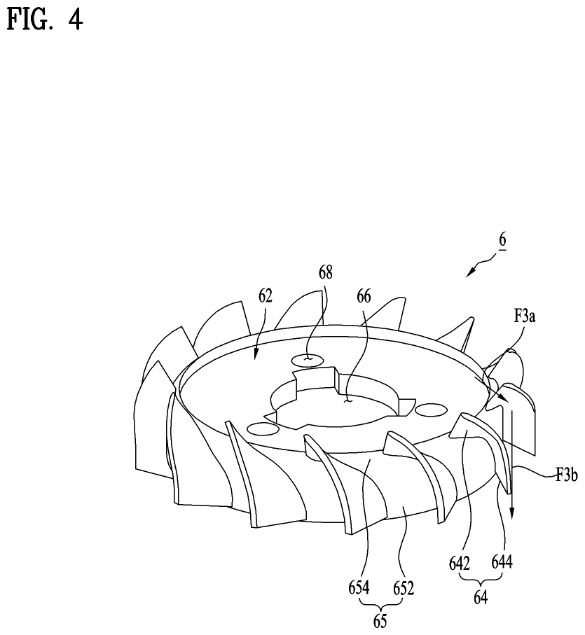

Another embodiment of the fan motor 1 is described with reference to FIG. 4.

A diffuser 6 of the present embodiment is described as follows.

First of all, a diffuser 6 may include a diffuser hub 62 and a vane 64. Particularly, a multitude of vanes 64 may be provided.

The diffuser hub 62 may be configured in a disk shape. An opening 66, in which the bearing housing 42 of the motor bracket 4 is inserted, may be provided to the diffuser hub 62. A shape of the opening 66 of the diffuser hub 62 may correspond to a shape of the bearing housing 42 of the motor bracket 4. Moreover, the diffuser hub 62 may be provided with a screw fastening recess 68 for screw-fastening the motor bracket 4 and the diffuser hub 62 to each other.

In some implementations, a multitude of the vanes 64 may be provided to an outer circumference 65 of the diffuser hub 62. Each of the vanes 64 may include an axial flow vane 644 and a diagonal flow vane 642. The diagonal flow vane 642 may play a diffusing role, and the axial flow vane 644 may play a role in increasing a flow rate by changing a flow direction into a downward direction.

The diagonal flow vane 642 may be located above the axial flow vane 644. For example, the axial flow vane 644 may be provided to a lateral side 652 of the outer circumference of the diffuser hub 62. The diagonal flow vane 642 may be provided to a top side 654 of the outer circumference of the diffuser hub 62. The diagonal flow vane 642 may be in a shape that an angle of a leading edge is inclined.

The axial flow vane 644 and the diagonal flow vane 642 may be separately provided. Preferably, the axial flow vane 644 and the diagonal flow vane 642 are connected continuously as a single vane.

In some implementations, generally, a space between the impeller 5 and the diffuser 6 is a vaneless section having no vane existing therein. Yet, a flow path loss is considerable in the vaneless section. Hence, a size of the diagonal flow vane 642 may become a size capable of covering the vaneless section if possible. For example, a top end of the diagonal vane 642 may be provided to be substantially adjacent to a bottom side of the impeller 5.

Meanwhile, the longer a total length of the vane of the diffuser 6 becomes, the better the vane gets. This is because a flow coming out of the impeller 5 can be guided more effectively if the total length of the vane gets longer. Hence, the total length of the vane of the diffuser 6 is preferably set longer. Besides, there is not much clearance under the diffuser 6. Hence, a length of the vane is extended over the diffuser 6.

Yet, in the present embodiment, the diagonal flow vane 642 may be provided above the axial flow vane 644. Namely, according to the present embodiment, the total length of the vane 64 gets longer by the length of the diagonal flow vane 642 without extending the length of the axial flow vane 644. Of course, at least one of the length of the axial flow vane 644 and the length of the diagonal flow vane 642 may be possibly increased.

An operation of the diffuser 6 according to the present embodiment is described with reference to FIG. 3 and FIG. 4 as follows.

In the present embodiment, the diagonal flow vane 642 is located at the portion where the flow F2 coming out of the impeller 5 flows into the diffuser 6. Hence, the flow F2 coming out of the impeller 5 is first guided by the diagonal flow vane 642, thereby becoming a flow F3a in an inclination direction. Hence, the flow coming out of the impeller 5 may move in a direction of the diffuser 6 more efficiently without a flow path loss.

Namely, the flow coming out of the impeller 5 is naturally discharged downward by the diagonal flow vane 642. Thus, the diagonal flow vane 642 restrains a rotation component of the flow and helps the flow to escape efficiently.

In addition, if the impeller 5 is a diagonal flow impeller, the flow escaping from the impeller 5 in a diagonal flow form may move more naturally along the diagonal flow vane 642. This is because the flow escaping from the impeller 5 in a diagonal flow form is naturally accepted by a start point of the diagonal flow vane 642. Moreover, a flow F3 guided to the diagonal flow vane 642 is delivered as a flow F3b in a motor direction by the axial flow vane 644.

Therefore, according to the present embodiment, a flow path loss may be minimized and flow path efficiency may be maximized. And, suction capability of the fan motor 1 may be raised efficiently.

Moreover, in the present embodiment, the diagonal flow vane 642 may be provided above the axial flow vane 644. Therefore, the diagonal flow vane 642 may be provided to the vaneless section, thereby minimizing the vaneless section between the impeller 5 and the diffuser 6.

In addition, in the present embodiment, a vane, e.g., the diagonal flow vane 642 may be additionally provided above the axial flow vane 644. Therefore, the total length of the vane of the diffuser 6 is increased, whereby a significant diffusing effect is obtained.

Operations of the fan motor 1 according to the present embodiment are described with reference to FIG. 2 as follows.

First of all, once the motor 2 rotates, the impeller 5 connected to the rotating shaft of the motor 2 is rotated. If the impeller 5 is rotated, air is sucked in through the inlet 74 of the impeller housing 7. Namely, a flow F1 in an approximately axial direction is generated.

The air sucked into the impeller housing 7 flows in the direction of the impeller 5. Here, the impeller 5 of the present embodiment may include a diagonal flow impeller. Hence, the flow F2 coming out of the impeller 5 moves downward at a prescribed inclination from a diameter direction. For example, the flow F2 may approximately lie between a radial direction and an axial direction. Namely, a direction of the flow F2 coming out of the impeller 5 is not turned rapidly. Thus, according to the present embodiment, a flow path loss is reduced.

The flow F2 coming out of the impeller 5 is naturally guided by the diagonal flow vane 642 of the diffuser 6 first. The flow F3 passing through the diagonal flow vane 642 becomes the flow F3B in the approximately axial direction by the axial flow vane 644. Namely, as the air flow is naturally guided in the diffuser 6, a flow path loss is reduced (See FIG. 3).

One portion of the flow coming out of the diffuser 6 becomes a flow F5 moving into the motor housing 3. The air flowing into the motor housing 3 cools down the motor 2 and is then externally discharged through the bottom opening 324 of the motor housing 3. The other portion of the flow coming out of the diffuser 6 becomes a flow F4 directly coming out of the motor housing.

In some implementations, when the fan motor according to the present disclosure is used for a cleaner, both of the flow F5 having passed through the motor housing 3 and the flow F4 failing to pass may move to a filter of the cleaner.

The matter of the above-described embodiment is identically applicable to other undescribed parts. Moreover, the technical matter described in one embodiment is identically applicable to another embodiment if it is not contrary mutually, unless otherwise specifically stated.

The above-described embodiments and drawings are used to help the understanding of the present disclosure. It will be appreciated by those skilled in the art that various modifications and variations can be made in the present disclosure without departing from the spirit or scope of the disclosures.

In the above-described embodiment, a fan motor having a diagonal flow impeller and an axial-diagonal flow diffuser is taken as an example. Yet, the axial-diagonal flow diffuser is applicable to a fan motor having a centrifugal impeller as well. And, a diagonal flow impeller is usable for a fan motor having an axial flow diffuser as well.

In addition, for example, a fan motor for a cleaner is described in the aforementioned embodiment, by which the present disclosure is non-limited. For example, the aforementioned fan motor is usable for home appliances other than the cleaner, vehicles, etc.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A fan motor, comprising:
a motor housing;
a motor disposed within the motor housing;
an impeller coupled to a shaft of the motor; and
a diffuser disposed between the motor and the impeller, the diffuser comprising an axial flow vane and a diagonal flow vane.

2. The fan motor of claim 1, wherein the impeller is a diagonal flow type impeller that is configured to receive fluid in a first direction and to output the fluid in a second direction different from the first direction.

3. The fan motor of claim 2, wherein the impeller comprises:
a hub that extends toward the motor housing, the hub having an outer surface that is inclined according to a prescribed angle with respect to an axial direction of the shaft; and
a blade arranged on the outer surface of the hub.

4. The fan motor of claim 3, wherein an inclination angle of the outer surface of the hub with respect to the axial direction varies from a top side of the hub to a bottom side of the hub.

5. The fan motor of claim 4, wherein the diagonal flow vane faces the impeller.

6. The fan motor of claim 5, wherein a leading edge of the diagonal flow vane faces the impeller and is inclined with respect to the axial direction.

7. The fan motor of claim 6, wherein the axial flow vane and the diagonal flow vane are integrally formed.

8. The fan motor of claim 7, wherein the diffuser further comprises a diffuser hub, and
wherein the axial flow vane and the diagonal flow vane are located on an outer circumference of the diffuser hub.

9. The fan motor of claim 8, wherein the diffuser hub has a disk shape,
wherein the axial flow vane is located on a lateral surface of the outer circumference of the hub, and
wherein the diagonal flow vane is located on a top portion of the outer circumference of the diffuser hub.

10. The fan motor of claim 9, wherein the top portion of the outer circumference of the diffuser hub comprises a curved surface.

11. A fan motor, comprising:
a motor housing;
a motor disposed within the motor housing;
an impeller coupled to a shaft of the motor;
a diffuser disposed between the motor and the impeller; and
a vane disposed between the impeller and the diffuser.

12. The fan motor of claim 11, wherein the diffuser comprises an axial flow vane and a diagonal flow vane, and
wherein the vane is the diagonal flow vane of the diffuser.

13. The fan motor of claim 12, wherein a leading edge of the diagonal flow vane is inclined with respect to an axial direction of the shaft.

14. The fan motor of claim 13, wherein the axial flow vane and the diagonal flow vane are integrally formed.

15. The fan motor of claim 14, wherein the impeller is a diagonal flow type impeller that is configured to receive fluid in a first direction and to output the fluid in a second direction different from the first direction.

16. The fan motor of claim 15, wherein the impeller comprises:
a hub that extends toward the motor housing, the hub having an outer surface that is inclined according to a prescribed angle with respect to the axial direction; and
a blade disposed on the outer surface of the hub.

17. The fan motor of claim 16, wherein an inclination angle of the outer surface of the hub with respect to the axial direction varies from a top side of the hub to a bottom side of the hub.

18. A fan motor, comprising:
a motor housing;
a motor disposed within the motor housing;
a diagonal flow impeller that is coupled to a shaft of the motor; and
a diffuser disposed between the motor and the diagonal flow impeller.

19. The fan motor of claim 18, wherein the diagonal flow impeller comprises:
a hub that extends toward the motor housing, the hub having an outer surface that is inclined according to a prescribed angle with respect to an axial direction of the shaft; and
a blade disposed on the outer surface of the hub.

20. The fan motor of claim 19, wherein an inclination angle of the outer surface of the hub with respect to the axial direction varies from a top side of the hub to a bottom side of the hub.
